(19) United States
(12) Patent Application Publication
(10) Pub. No.: US 2008/0130981 A1
(43) Pub. Date: Jun. 5, 2008

(54) MASK PATTERN MATCHING METHOD AND MASK PATTERN MATCHING APPARATUS USING THE SAME

(75) Inventor: Hyung-Joo Lee, Gyeonggi-do (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/943,302

(22) Filed: Nov. 20, 2007

(30) Foreign Application Priority Data
Nov. 24, 2006 (KR) 10-2006-0117024

(51) Int. Cl. G06K 9/00

(52) U.S. Cl. 382/144

(57) ABSTRACT

Mask pattern matching methods and apparatus are described. A mask pattern matching method comprises: presetting, in a measuring device, distinct tones of line and space of a mask circuit pattern, respectively; positioning a mask including an alignment mark on a stage; positioning the measuring device above the mask so as to be aligned with a position of the alignment mark, and setting a measurement region; distinguishing light and darkness of the line and space of a circuit pattern formed on the mask within the measurement region by the measuring device, based on the distinct tones; and matching a circuit pattern formed on the entire region of the mask by the measuring device, based on the distinct tones.

### CROSS-REFERENCE TO RELATED APPLICATION

This application claims priority from Korean Patent Application No. 2006-0117024, filed Nov. 24, 2006, the disclosure of which is hereby incorporated herein by reference in its entirety as if set forth fully herein.

### FIELD OF THE INVENTION

The present invention relates generally to semiconductor devices and, more particularly, to methods and apparatus for fabricating semiconductor devices.

### BACKGROUND

Generally, a semiconductor device is fabricated by sequentially or selectively performing a number of unit processes, such as diffusion, deposition, exposure, ion implantation and etching processes. As the integration density of a semiconductor device has been improved, the critical dimension (CD) of a circuit pattern has been reduced. Thus, the circuit patterns which are very small in CD are patterned on a mask which is used for the exposure process.

Accordingly, semiconductor device fabrication processes may need a technique for accurately measuring the CD of a circuit pattern having improved integration density.

For example, a CD SEM (scanning electron microscope) uses a relatively small measurement field compared to an optical system. Consequently, a CD SEM has a number of measurement points on a circuit pattern. A CD SEM needs to measure the CD of the circuit pattern while automatically moving to a number of the measurement points. In a typical automatic measurement, when circuit patterns to be measured are different in shape, upon making a recipe, it is necessary to capture and set an image for pattern matching according to the shape of each pattern. This may increase the time for capturing and setting the image for pattern matching.

To solve the aforementioned problem, a CAD link system has been employed. In a CAD link system, coordinates for a circuit pattern to be measured are preset. When only the coordinates as set are given, a measurement recipe is made. Accordingly, a CAD link system may reduce the time required for capturing and setting an image for pattern matching.

However, in a CAD link system, the information of line and space is stored as a bitmap image. That is, the bitmap image is divided into two regions of two brightness, i.e., black and white. Generally, black of a dark tone is recognized as a space, and white of a light tone is recognized as a line. Accordingly, when pattern matching is performed in the CAD link system, black in a circuit pattern to be measured is recognized as a space, and white is recognized as a line.

Consequently, when measuring a circuit pattern formed on a mask during processes for fabricating a semiconductor device, it may be difficult to accurately measure the contrast between light and darkness of the line and space according to combinations of different materials relating to corresponding processes or masks.

FIG. 1 illustrates a plurality of images for circuit pattern matching. As illustrated in FIG. 1, the light and darkness of line and space are differently formed according to combinations of different materials on masks.

In a CAD link system, light portions of BIN ACl and PSM Mo-Final are accurately recognized as lines and dark portions thereof are accurately recognized as spaces. However, light portions of PSM CrACl are recognized as spaces, and dark portions thereof are recognized as lines.

This problem may cause a fatal result in a CAD link system which is to measure several hundred points. Moreover, it may increase the time required for detecting the points (i.e., error points) which are inversely recognized as described above.

### SUMMARY OF THE INVENTION

Therefore, the present invention provides a mask pattern matching method which accurately distinguishes line and space of a circuit pattern to be measured when matching a mask circuit pattern, by pre-recognizing distinct tones for the line and space, and a mask pattern matching apparatus using the same.

The present invention also provides a mask pattern matching method which accurately recognizes a boundary between line and space, by acquiring an edge profile of a mask circuit pattern to be measured, using distinct tones for line and space being pre-recognized, and a mask pattern matching apparatus using the same

In accordance with an exemplary embodiment, the present invention provides a mask pattern matching method comprising: presetting distinct tones of lines and space of a mask circuit pattern, respectively; and distinguishing light and darkness of the line and space of the circuit pattern formed on a mask, based on the distinct tones.

The distinct tones may be determined according to materials of the mask.

An edge profile of the line and space may be recognized, based on the distinct tones.

In accordance with another exemplary embodiment, the present invention provides a mask pattern matching method comprising: presetting, in a measuring device, distinct tones of line and space of a mask circuit pattern, respectively; positioning a mask including an alignment mark on a stage; positioning the measuring device above the mask so as to be aligned with a position of the alignment mark, and setting a measurement region; distinguishing light and darkness of the line and space of a circuit pattern formed on the mask within the measurement region by the measuring device, based on the distinct tones; and matching a circuit pattern formed on the entire region of the mask by the measuring device, based on the distinct tones.

When a unique pattern exists in the circuit pattern of the mask positioned on the stage, the measurement region may include the unique pattern.

After positioning the measuring device to be aligned with the position of the alignment mark, the method may further comprise: positioning the measuring device on any one region among the entire region of the mask; matching a circuit pattern formed on the any one region; comparing whether the circuit pattern being matched is matching based on the distinct tones being preset; and when the circuit pattern is not matching based on the distinct tones, setting the measurement region.

The measurement region may be formed by detecting an edge of a circuit pattern being adjacent from the center of the measurement region, and light and darkness of the line and space of the circuit pattern based on the edge being detected may be distinguished based on the distinct tones.

The distinct tones may be determined according to materials of the mask.

An edge profile of the line and space may be recognized, based on the distinct tones.

In another aspect of the present invention, the present invention provides a mask pattern matching apparatus.

The mask pattern matching apparatus comprises: a stage on which a mask including an alignment mark is held; a measuring device, in which distinct tones of line and space of a circuit pattern formed on the mask, matching the circuit pattern, based on the distinct tones; and an aligning unit aligning the measuring device above the mask.

The distinct tones may be determined according to materials of the mask.

When matching the circuit pattern based on the distinct tones, the measuring device may further comprise: a selection unit which offers the option of performing the pattern matching by being aligned above the mask, performing the pattern matching by searching a unique pattern of a circuit pattern formed on the mask, or performing the pattern matching by selecting any region among the entire region of the upper part of the mask.

When performing the pattern matching by being aligned above the mask, the measuring device may be positioned above the mask so as to be aligned with the position of the alignment mark, set a measurement region, distinguish light and darkness of the line and space of the circuit pattern formed on the mask within the measurement region, based on the distinct tones, and match a circuit pattern formed on the entire region of the mask, based on the distinct tones.

When performing the pattern matching by searching the unique pattern of the circuit pattern formed on the mask, the measuring device may be positioned above the mask on which the unique pattern is formed, set a measurement region, distinguish light and darkness of the line and space of the circuit pattern formed on the mask within the measurement region, based on the distinct tones, and match a circuit pattern formed on the entire region of the mask, based on the distinct tones.

When performing the pattern matching by selecting any one region among the entire region of the upper part of the mask, the measuring device may be aligned with the position of the alignment mark, be positioned on any one region among the entire region of the mask, match a circuit pattern formed on the any one region, compare whether the circuit pattern being matched is matching based on the distinct tones being preset, and, when the circuit pattern is not matching based on the distinct tones, set the measurement region.

The measurement region may be formed by detecting an edge of a circuit pattern being adjacent from the center of the measurement region, and light and darkness of the line and space of the circuit pattern based on the edge being detected may be distinguished based on the distinct tones.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 illustrates a plurality of images for circuit pattern matching;

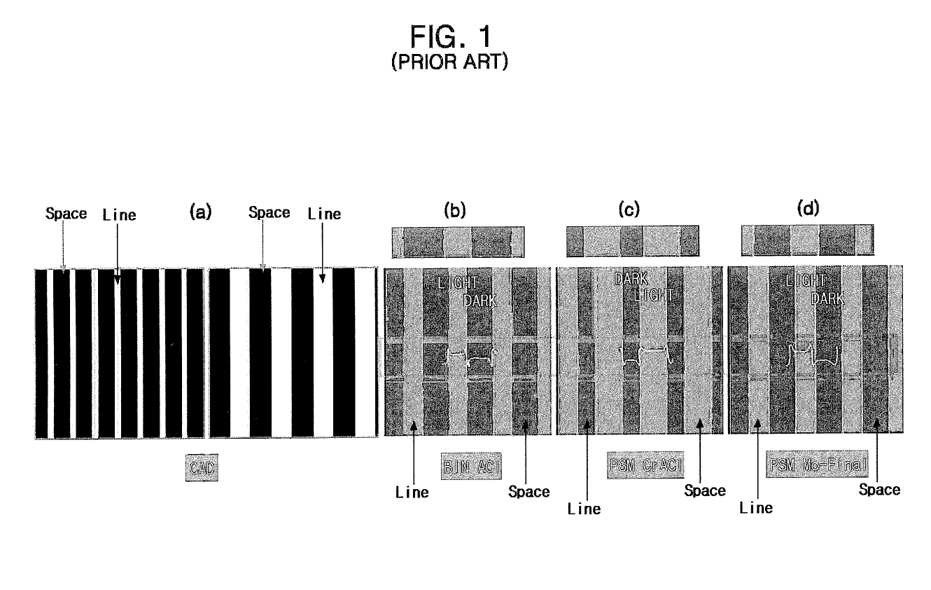

FIG. 2 illustrates mask pattern matching images according to an embodiment of the present invention;

FIG. 3 is a flow chart illustrating a mask pattern matching method according to an embodiment of the present invention;

FIG. 4 illustrates mask pattern matching images according to another embodiment of the present invention;

FIG. 5 is a flow chart illustrating a mask pattern matching method according to another embodiment of the present invention;

FIG. 6 illustrates mask pattern matching images according to another embodiment of the present invention;

FIG. 7 is a flow chart illustrating a mask pattern matching method according to another embodiment of the present invention;

FIG. 8 is a flow chart illustrating a mask pattern matching method according to another embodiment of the present invention; and

FIG. 9 is a schematic view illustrating a mask pattern matching apparatus according to the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as being limited to the embodiments set forth herein. Rather, these embodiments are provided so that this disclosure will be thorough and complete, and will fully convey the scope of the invention to those skilled in the art.

The invention will be described more fully hereinafter with reference to the accompanying drawings, in which example embodiments of the invention are shown. This invention may, however, be embodied in many different forms and should not be construed as limited to the example embodiments set forth herein. Rather, the disclosed embodiments are provided so that this disclosure will be thorough and complete, and will fully convey the scope of the invention to those skilled in the art. In the drawings, the size and relative sizes of layers and regions may be exaggerated for clarity. Moreover, each embodiment described and illustrated herein includes its complementary conductivity type embodiment as well. Like numbers refer to like elements throughout.

It will be understood that when an element or layer is referred to as being “on”, “connected to” and/or “coupled to” another element or layer, it can be directly on, connected or coupled to the other element or layer or intervening elements or layers may be present. In contrast, when an element is referred to as being “directly on,” “directly connected to” and/or “directly coupled to” another element or layer, there are no intervening elements or layers present. As used herein, the term “and/or” may include any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms may be used to distinguish one element, component, region, layer and/or section from another region, layer and/or section. For example, a first element, component, region, layer and/or section discussed below could be termed a second element, component, region, layer and/or section without departing from the teachings of the present invention.

Spatially relative terms, such as “below”, “lower”, “above”, “upper” and the like, may be used herein for ease of description to describe an element and/or a feature's relationship to another element(s) and/or feature(s) as illustrated in the figures. It will be understood that the spatially relative terms are intended to encompass different orientations of the device in use or operation in addition to the orientation depicted in the figures. For example, if the device in the figures is turned over, elements described as “below” other elements or features would then be oriented “above” the other elements or features. Thus, the example term “below” can encompass both an orientation of above and below. The device may be otherwise oriented (rotated 90° or at other orientations) and the spatially relative descriptors used herein interpreted accordingly. Moreover, the term “beneath” indicates a relationship of one layer or region to another layer or region relative to the substrate, as illustrated in the figures.

The terminology used herein is for the purpose of describing particular embodiments only and is not intended to be limiting of the invention. As used herein, the singular terms “a”, “an” and “the” are intended to include the plural forms as well, unless the context clearly indicates otherwise. It will be further understood that the terms “comprises,” “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof.

Example embodiments of the invention are described herein with reference to plan and cross-section illustrations that are schematic illustrations of idealized embodiments (and intermediate structures) of the invention. As such, variations from the shapes of the illustrations as a result, for example, of manufacturing techniques and/or tolerances, may be expected. Thus, the disclosed example embodiments of the invention should not be construed as limited to the particular shapes of regions illustrated herein unless expressly so defined herein, but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention, unless expressly so defined herein.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

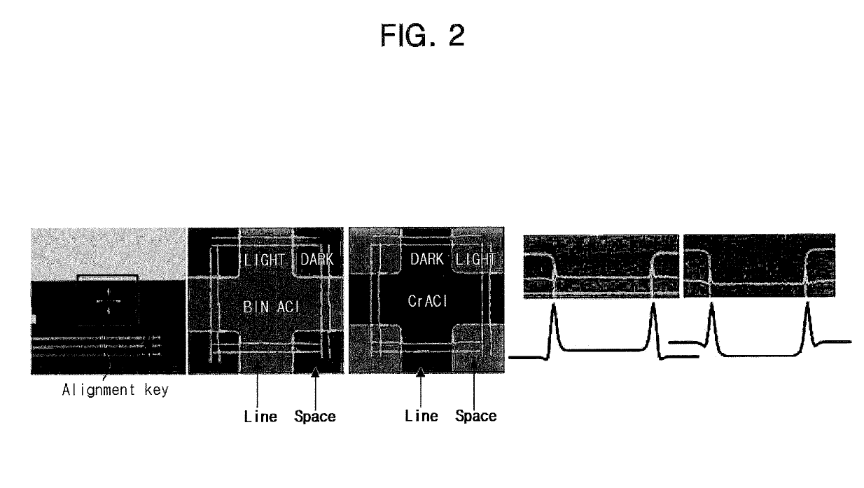

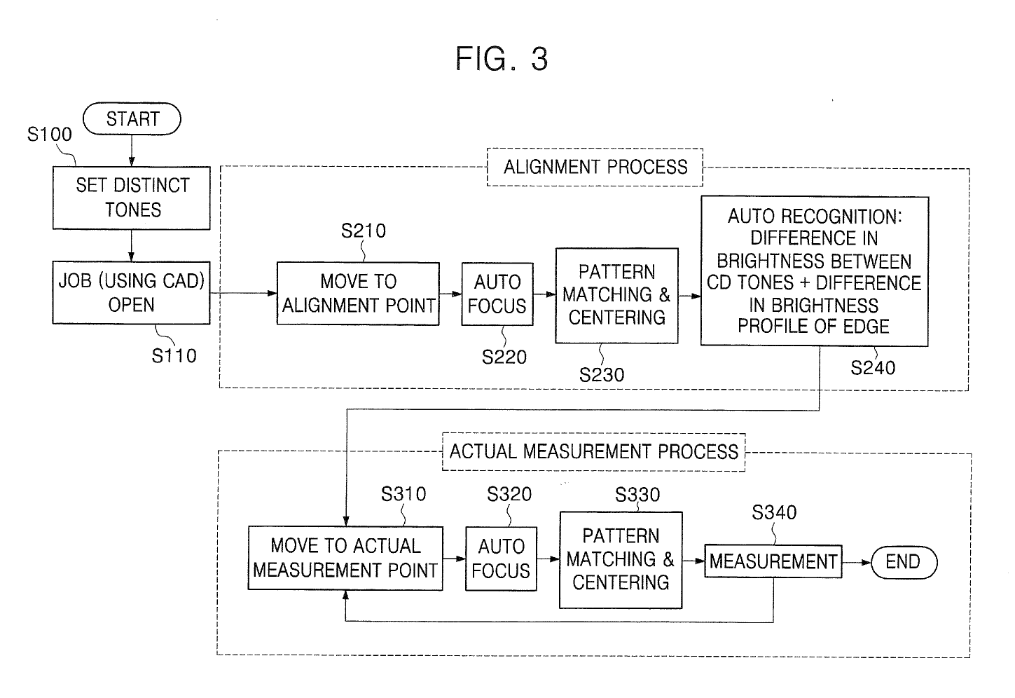

A mask pattern matching method according to an embodiment of the present invention will be described with reference to FIGS. 2 and 3.

FIG. 2 illustrates mask pattern matching images according to an embodiment of the present invention, and FIG. 3 is a flow chart illustrating a mask pattern matching method according to an embodiment of the present invention.

Referring to FIGS. 2 and 3, the mask illustrated pattern matching method comprises presetting respective distinct tones for line and space of a mask circuit pattern (S100). Light and darkness of the line and space of a circuit pattern formed on the mask are distinguished, based on the distinct tones.

Specifically, the distinct tones are pre-stored in a job file (S100). The distinct tones of line and space are determined according to materials of the mask, as illustrated in FIG. 2. For example, as illustrated in FIG. 2, when the mask is composed of BIN ACl, the line is light and the space is dark. On the contrary, when the mask is composed of CrACl, the line is dark and the space is light.

The distinct tones of line and space according to the materials of the mask are pre-stored in the job file. The job file may be built in a measuring device 100.

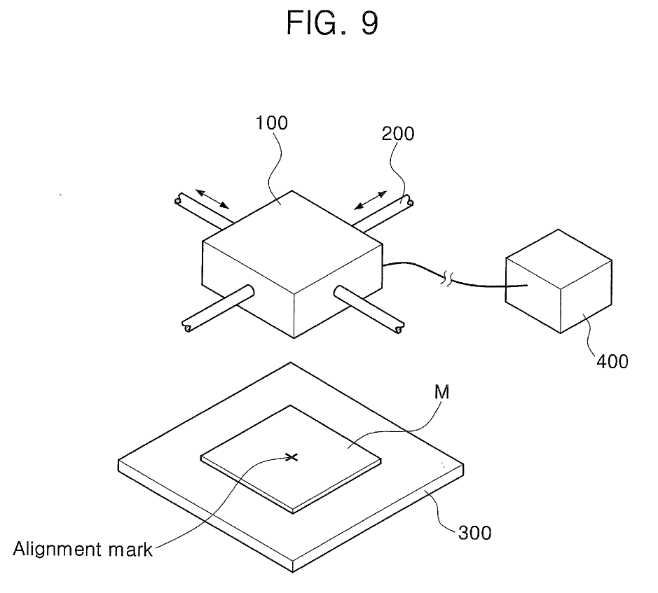

After the job file is opened (S110), the measuring device 100 (FIG. 9) is positioned above the mask prepared on a stage 300 (FIG. 9), the mask having an alignment mark (FIG. 9) formed thereon (S210). The measuring device 100 includes an image window (not shown) to obtain an image of an upper part of the mask. A center mark (not shown) for centering is formed in the center of the image window.

Subsequently, the measuring device 100 positioned above the mask controls the focus of a circuit pattern formed on the mask (S220) and aligns the center mark formed on the image window and the alignment mark (S230).

After setting a measurement region in a predetermined size on the circuit pattern of the mask, the measuring device 100 distinguishes the line and space of the circuit pattern of the mask, based on the distinct tones, and measures an edge profile of the circuit pattern (S240).

For example, referring to FIG. 2, when the material of the mask is BIN ACl, the line is preset as a light tone and the space is preset as a dark tone in the job file of the measuring device 100. Accordingly, the measuring device 100 clearly distinguishes the difference in brightness of the line and space of the circuit pattern, based on the distinct tones.

After the line and space of the circuit pattern are distinguished, based on the distinct tones, the measuring device 100 is moved to one region among the entire regions of the upper surface of the mask (S310). That is, the measuring device 100 is moved to an actual measurement region for matching a circuit pattern formed on the mask.

Subsequently, when the measuring device 100 is moved to the actual measurement region, the measuring device 100 adjusts the focus of the circuit pattern of the mask (S320) and aligns the center mark of the image window and the alignment mark of the mask, thereby matching the circuit pattern (S330). Then, the measuring device 100 performs measurement of the circuit pattern (S340).

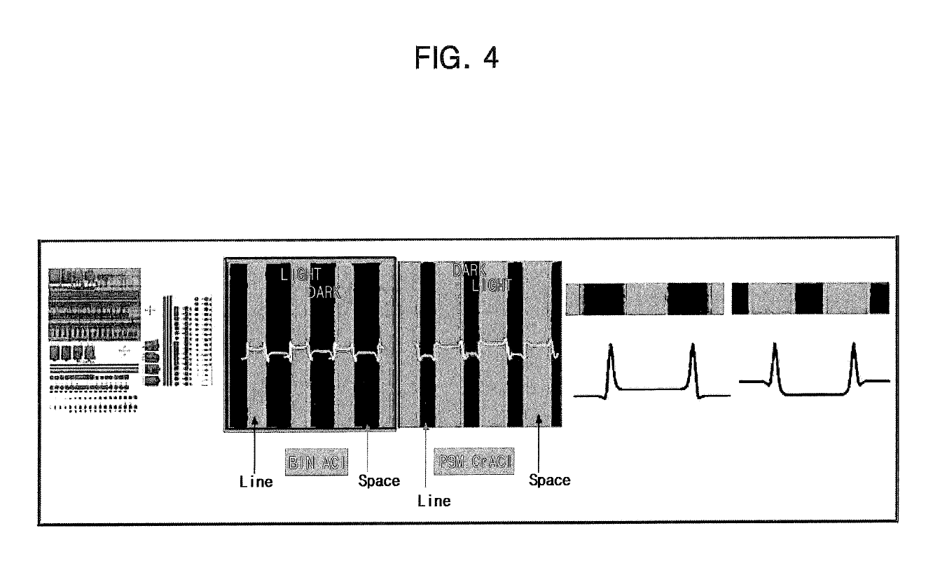

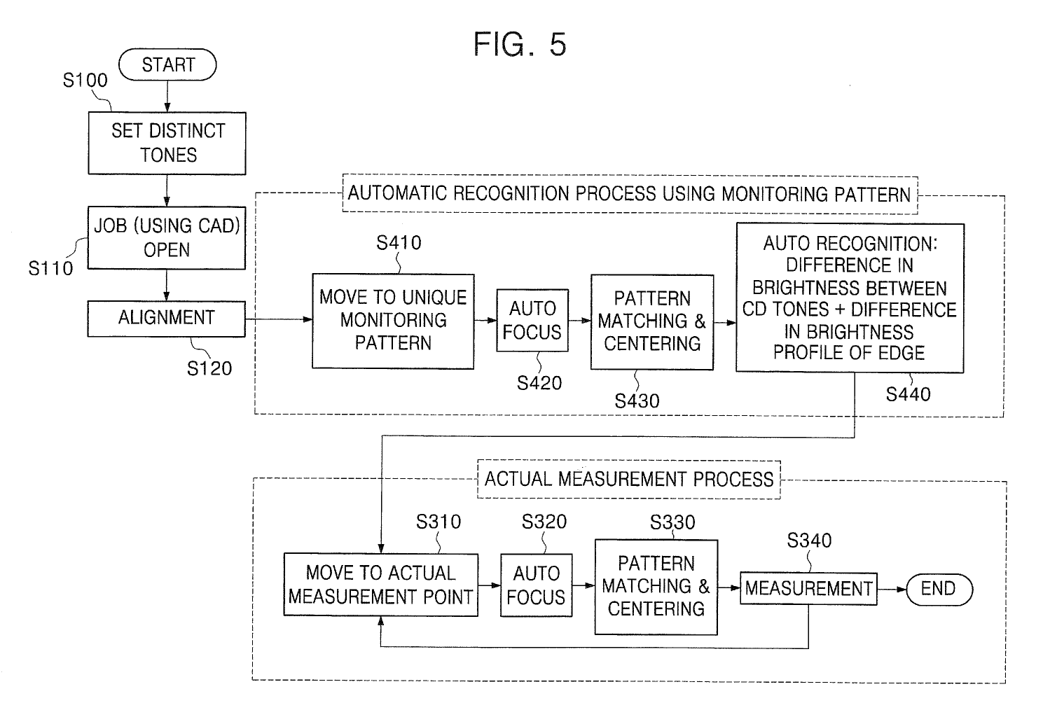

A mask pattern matching method according to another embodiment of the present invention will be described with reference to FIGS. 4 and 5.

FIG. 4 illustrates mask pattern matching images according to another embodiment of the present invention, and FIG. 5 is a flow chart illustrating a mask pattern matching method according to another embodiment of the present invention.

In the embodiment of FIGS. 4 and 5, a unique pattern is formed in a circuit pattern of a mask.

Referring to FIGS. 4 and 5, a process of opening a job file and positioning a measuring device 100 above an alignment mark formed on a mask is same as the process (S100 to S120) described in the embodiment with reference to FIGS. 2 and 3.

The measuring device 100 sets a measurement region including a portion where the unique pattern is formed, among the regions of a circuit pattern of the mask. The measurement region may be stored in the job file. That is, the measuring device 100 is moved to a unique monitoring pattern (S410). The measuring device 100 focuses the measurement region including the unique pattern (S420) and aligns a center mark of an image window and the center of the measurement region (S430), like the embodiment of FIGS. 2 and 3.

The measuring device 100 distinguishes light and darkness of the line and space of the circuit pattern positioned within the measurement region, using distinct tones being preset (S440). In addition, the measuring device 100 measures an edge profile of the line and space and stores in the job file.

Accordingly, the measuring device 100 is capable of distinguishing light and darkness of the line and space in the measurement region including the unique pattern. Referring to FIG. 4, when the material of the mask is BIN ACl, the line and space are distinguished based on the distinct tones in which the line is set as a light tone and the space is set as a dark tone.

Subsequently, like the embodiment of FIGS. 2 and 3, the measuring device 100 sets one region among the entire region of the mask (S310), adjusts the focus of the circuit pattern included in the region being set (S320), and aligns the center mark of the image window and the center of the region being set, thereby performing circuit pattern matching (S330). Then, the measuring device 100 performs measurement (S340).

Accordingly, in the embodiment of FIGS. 4 and 5, the tones of the line and space in the measurement region including the unique pattern formed on the mask are distinguished, and the distinct tones are set in the job file. Consequently, after a recipe for pattern matching by an actual SEM image is stored in the job file, the recipe is used together with the measuring device 100 if necessary, thereby easily realizing the pattern matching.

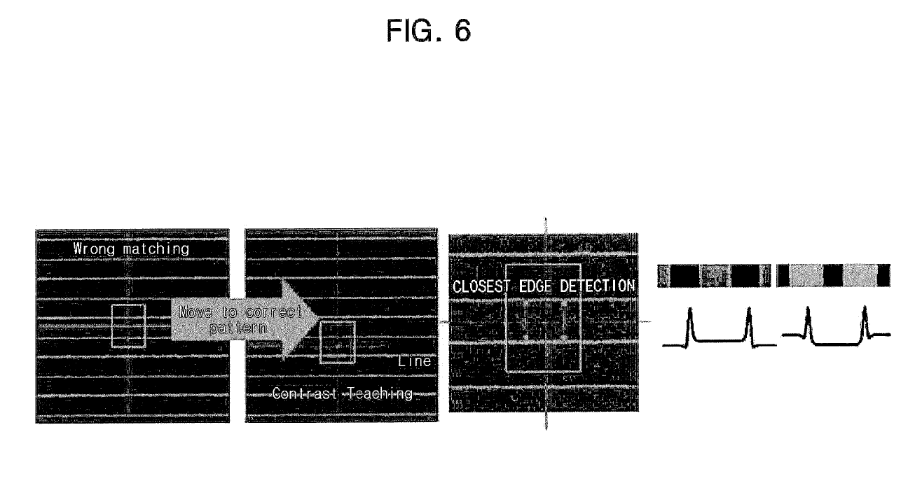

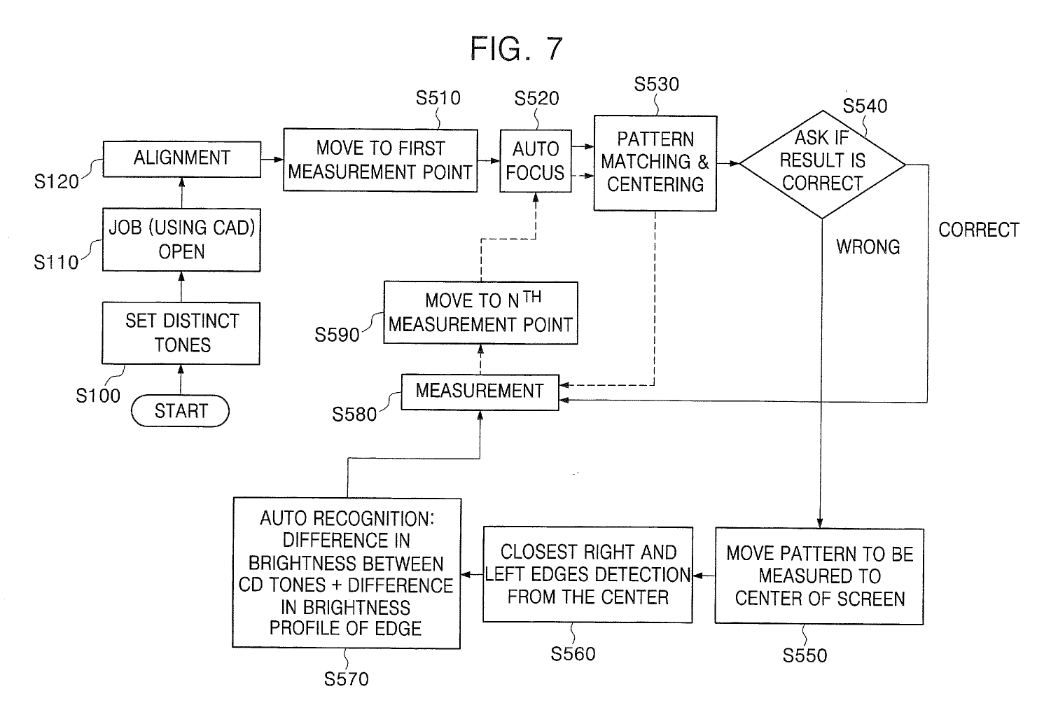

A mask pattern matching method according to another embodiment of the present invention will be described with reference to FIGS. 6 and 7.

FIG. 6 illustrates mask pattern matching images according to another embodiment of the present invention, and FIG. 7 is a flow chart illustrating a mask pattern matching method according to another embodiment of the present invention.

In the embodiment of FIGS. 6 and 7, a measuring device 100 sets a measurement region at any position of a mask M and performs pattern matching. An operator compares a result of the pattern matching. When the result of the pattern matching is wrong, tones of line and space of a circuit pattern are distinguished by using distinct tones, like the embodiments of FIGS. 2 through 5.

The mask pattern matching method according to the embodiment of FIGS. 6 and 7 will be described in more detail.

A process of positioning a job file and a measuring device 100 above an alignment mark formed on a mask M is same as the process (S100 to S120) described in the embodiments with reference to FIGS. 2 through 5.

The measuring device 100 selects any circuit pattern region on the mask and sets the region as a measurement region (S510). For example, this measurement region is a first measurement region. The measurement region may be set up to nth measurement region.

When the first measurement region is set (S510), the measurement device 100 focuses the circuit pattern included in the first measurement region (S520) and aligns a center mark of an image window of the measuring device 100 and the center of the first measurement region, thereby matching the circuit pattern (S530).

Then, a result of matching the circuit pattern is indicated on an image result window which is separately provided in the measuring device 100. An operator determines whether the line and space of the circuit pattern indicated on the image result window are accurately recognized (S540). The operator needs to input the determination of the result into the measuring device 100.

When the result of matching the circuit pattern is not consistent, that is, the line and space are inversely recognized, the operator inputs the result into the measuring device 100.

The measuring device 100 aligns the center of the first measurement region and the center mark of the image window (S550) and detects an edge being adjacent from the center aligned with the center mark (S560).

Subsequently, the measuring device 100 distinguishes the tones of the regions classified into the edge, based on the distinct tones being preset (S570). When the distinct tones set a light tone as a line and a dark tone as a space, the measuring device 100 distinguishes the tones of the line and space of the regions (S580).

Subsequently, like the other embodiments as described above, the measuring device 100 sets one region among the entire region of the mask (S590), adjusts the focus of the circuit pattern included in the region (S520) and aligns the center mark of the image window and the center of the region, thereby performing the circuit pattern matching (S530) and measurement (S580).

When the result of the circuit pattern matching is same, that is, the line and space are accurately recognized, the measuring device 100 performs the measurement of the circuit pattern included in the first measurement region (S580).

In the embodiment of FIGS. 6 and 7, the measuring device performs the circuit pattern matching in the first measurement region among the region in which the circuit pattern of the mask is formed. However, the circuit pattern regions may be from the first region to nth region. Accordingly, after completing the circuit pattern matching of the first measurement region as described above, circuit pattern matching for the rest n−1 regions may be sequentially performed by the same method.

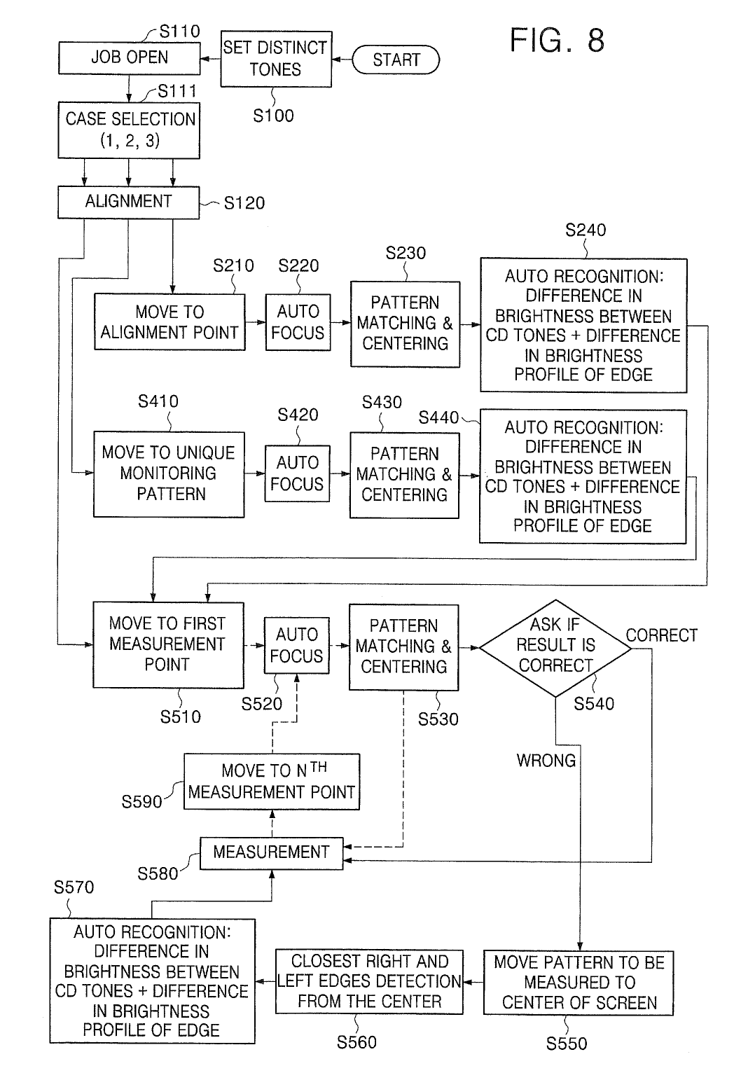

FIG. 8 illustrates a mask pattern matching method according to another embodiment of the present invention.

Referring to FIG. 8, a process of opening a job file and positioning a measuring device 100 above an alignment mark formed on a mask is the same as the process (S100 to S120) described in the embodiments with reference to FIGS. 2 through 7.

However, the measuring device 100 in the embodiment of FIG. 8 further comprises a selection unit 400 (FIG. 9). When the measuring device 100 performs matching of a circuit pattern based on distinct tones, the section unit 400 offers the option of performing circuit pattern matching by being aligned above the mask (case 1), performing circuit pattern matching by searching a unique pattern of a circuit pattern formed on the mask (case 2), or performing circuit pattern matching by selecting any one region among the entire region of the upper part of the mask (case 3) (S1).

When case 1 is selected by the section unit 400, the mask pattern matching is performed by the same method (S210 to S240) described in the embodiment of FIGS. 2 and 3. When case 2 is selected, the mask pattern matching is performed by the same method (S410 to S440) described in the embodiment of FIGS. 4 and 5. When case 3 is selected, the mask pattern matching is performed by the same method (S510 to S590) described in the embodiment of FIGS. 6 and 7.

Next, a mask pattern matching apparatus according to an embodiment of the present invention will be described.

Referring to FIG. 9, the mask pattern matching apparatus comprises: a stage 300 on which a mask M having an alignment mark is held; a measuring device 100 presetting distinct tones of line/space of a circuit pattern formed on the mask M respectively and matching the circuit pattern based on the distinct tones; and an aligning unit 200 aligning the measuring device 100 above the mask M.

The aligning unit 200 may be a movable device which is capable of moving the measuring device 100 above the alignment mark formed on the mask M, thereby aligning the measuring device 100.

The distinct tones may be determined according to materials of the mask M.

Referring to FIG. 8, when the measuring device 100 matches the circuit pattern based on the distinct tones, the measuring device 100 may further comprise a section unit 400 which offers the option of performing circuit pattern matching by being aligned above the mask (case 1), performing circuit pattern matching by searching a unique pattern of a circuit pattern formed on the mask (case 2), or performing circuit pattern matching by selecting any one region among the entire region of the upper part of the mask (case 3).

When the circuit pattern matching is performed by being aligned above the mask M, the measuring device 100 is positioned above the mask M so as to be aligned with the alignment mark. Then, the measuring device 100 sets a measurement region and distinguishes light and darkness of the line and space of a circuit pattern formed on the mask within the measurement region, based on the distinct tones, thereby matching a circuit pattern formed on the entire region of the mask, based on the distinct tones (as described in the embodiment of FIGS. 2 and 3).

When the circuit pattern matching is performed by searching a unique pattern of a circuit pattern formed on the mask M, the measuring device 100 is positioned above the mask M on which the unique pattern is formed. Then, the measuring device 100 sets a measurement region and distinguishes light and darkness of the line and space of the circuit pattern formed on the mask M within the measurement region, based on the distinct tones, thereby matching a circuit pattern formed on the entire region of the mask M, based on the distinct tones (as described in the embodiment of FIGS. 4 and 5).

When the circuit pattern matching is performed by selecting any one region among the entire region of the upper part of the mask, the measuring device is positioned to be aligned with the position of the alignment mark and then is positioned on any one region among the entire region of the mask M. The measuring device matches a circuit pattern formed on the one region. Whether the circuit pattern being matched matches based on the distinct tones as preset is compared. When the circuit pattern is not matching based on the distinct tones, the measurement region is set. The measurement region is formed by detecting an edge of the circuit pattern being adjacent to the center of the measurement region. The light and darkness of the line and space of the circuit pattern based on the detected edge are distinguished, using the distinct tones (as described in the embodiment of FIGS. 6 and 7).

As described above, in the present invention, since the distinct tones are preset in a job file, a difference in brightness between actual line and space patterns and a brightness profile of an edge are automatically recognized, during the alignment process which is a requirement for measurement, that is, in the step of positioning the measuring device above the alignment mark formed on the mask. Accordingly, upon the pattern matching of an actual measurement point, the line and space are more accurately distinguished in the present invention, compared to the information of line and space recognized by applying the same algorithm. Consequently, the pattern is matched with the enhanced accuracy in distinguishing the line and space of the circuit pattern according to materials of the mask.

Furthermore, in the present invention, since measurement is preceded using the line/space pattern, a success rate of automatic measurement is guaranteed, thereby reducing the difference between a bitmap image on CAD and an actual SEM image when using the CAD link system of a CD SEM. Since the difference in brightness between line and space, and the brightness profile of an edge are automatically recognized, the line and space are automatically distinguished in the recipe made using the CAD link system.

Furthermore, in the present invention, after the measuring device moves to the first measurement region and performs the pattern matching, an operator determines the result of the pattern matching, thereby reducing the difference between an actual SEM image and a CAD image when using the CAD link system. The operator designates the center of a correct pattern and detects an edge which is closest from the center of the designated pattern, so that the difference in brightness between line and space and the brightness profile of the edge are automatically recognized, and the pattern matching in the other measurement regions is performed, based on the recognized information.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A mask pattern matching method comprising:
presetting distinct tones of lines and space of a mask circuit pattern, respectively; and
distinguishing light and darkness of the line and space of the circuit pattern formed on a mask, based on the distinct tones.

2. The method of claim 1, wherein the distinct tones are determined according to materials of the mask.

3. The method of claim 1, wherein an edge profile of the line and space is recognized, based on the distinct tones.

4. A mask pattern matching method comprising:
presetting, in a measuring device, distinct tones of line and space of a mask circuit pattern, respectively;
positioning a mask including an alignment mark on a stage;
positioning the measuring device above the mask so as to be aligned with a position of the alignment mark, and setting a measurement region;
distinguishing light and darkness of the line and space of a circuit pattern formed on the mask within the measurement region by the measuring device, based on the distinct tones; and
matching a circuit pattern formed on the entire region of the mask by the measuring device, based on the distinct tones.

5. The method of claim 4, wherein, when a unique pattern exists in the circuit pattern of the mask positioned on the stage, the measurement region comprises the unique pattern.

6. The method of claim 4, further comprising:
after positioning the measuring device to be aligned with the position of the alignment mark, positioning the measuring device on any one region among the entire region of the mask;
matching a circuit pattern formed on the one region;
comparing whether the circuit pattern being matched is matching based on the distinct tones being preset; and
when the circuit pattern is not matching based on the distinct tones, setting the measurement region.

7. The method of claim 6, wherein the measurement region is formed by detecting an edge of a circuit pattern being adjacent from the center of the measurement region, and light and darkness of the line and space of the circuit pattern based on the edge being detected are distinguished based on the distinct tones.

8. The method of claim 4, wherein the distinct tones are determined according to materials of the mask.

9. The method of claim 4, wherein an edge profile of the line and space is recognized, based on the distinct tones.

10. A mask pattern matching apparatus comprising:
a stage on which a mask including an alignment mark is held;
a measuring device, in which distinct tones of line and space of a circuit pattern formed on the mask are preset respectively, matching the circuit pattern, based on the distinct tones; and
an aligning unit configured to align the measuring device above the mask.

11. The apparatus of claim 10, wherein the distinct tones are determined according to materials of the mask.

12. The apparatus of claim 10, wherein, when matching the circuit pattern based on the distinct tones, the measuring device further comprises a selection unit configured to offer a user the option of performing pattern matching by being aligned above the mask, performing pattern matching by searching a unique pattern of a circuit pattern formed on the mask, or performing pattern matching by selecting any one region among the entire region of the upper part of the mask.

13. The apparatus of claim 12, wherein, when performing pattern matching by being aligned above the mask, the measuring device is configured to be positioned above the mask so as to be aligned with the position of the alignment mark, to set a measurement region, to distinguish light and darkness of the line and space of the circuit pattern formed on the mask within the measurement region, based on the distinct tones, and to match a circuit pattern formed on the entire region of the mask, based on the distinct tones.

14. The apparatus of claim 12, wherein, when performing the pattern matching by searching the unique pattern of the circuit pattern formed on the mask, the measuring device is configured to be positioned above the mask on which the unique pattern is formed, to set a measurement region, to distinguish light and darkness of the line and space of the circuit pattern formed on the mask within the measurement region, based on the distinct tones, and to match a circuit pattern formed on the entire region of the mask, based on the distinct tones.

15. The apparatus of claim 12, wherein, when performing the pattern matching by selecting any one region among the entire region of the upper part of the mask, the measuring device is configured to be aligned with the position of the alignment mark, to be positioned on any one region among the entire region of the mask, to match a circuit pattern formed on the one region, to compare whether the circuit pattern being matched is matching based on the distinct tones being preset, and, when the circuit pattern is not matching based on the distinct tones, to set the measurement region.

16. The apparatus of claim 15, wherein the measurement region is formed by detecting an edge of a circuit pattern being adjacent from the center of the measurement region, and light and darkness of the line and space of the circuit pattern based on the edge being detected are distinguished based on the distinct tones.
